(19) United States
(12) Patent Application Publication
(10) Pub. No.: US 2007/0239352 A1
(43) Pub. Date: Oct. 11, 2007

(54) Embedded dynamic map generation

(75) Inventors: Chandrasekhar Thota, Redmond, WA (US); Matthew Cheung, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/401,040

(22) Filed: Apr. 10, 2006

(51) Int. Cl. G01C 21/32

(52) U.S. Cl. 701/208; 701/211

(57) ABSTRACT

A unique map generation system and method are provide that facilitates automatically detecting a user's (or user's device's) current location and generating at least one customized map view of a static location based on the current (dynamic) location of the user. Many portable and handheld devices have very small user interfaces and limited means of entering alphanumeric information. Network-based content such as web pages offer generic map views of a location of the content but without consideration of the user's location. Traditional systems require entry of the relevant data (e.g., address information) in order to obtain or generate a map view or directions. However, in the subject system, the user's location can be automatically detected and “entered” and a customized map view for this current location in relation to the content's location can be created—thus with minimal user input or action.

### BACKGROUND

Conventional mapping systems generally require users to enter information into a series of fields before a map that is truly useful is made available. The types of required information often include a starting or current address location and the address information for the intended destination. For example, on the Internet, individual websites more commonly offer a view of a business's actual location and sometimes directions can be provided through the use of a third party service. Regardless of the content type or the viewing options offered, most if not all content created for use by an end user requires explicit entry of input by a user in order to receive meaningful information in return. This is especially problematic given the ever-shrinking size of computing devices. From mini-laptops, PDAs, smart phones, and mobile phones, display screens are getting smaller and input means are becoming increasingly more limited. Auto-fill or auto-suggest features have attempted to alleviate some of the burden, however, these features are not always available. When available, however, they can still be cumbersome to activate given such limited input means or else do not provide all the needed information to generate a useful map.

### SUMMARY

The following presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

The subject application relates to a system(s) and/or methodology that facilitate providing map related information to a user with minimal user action or data entry. In particular, the systems and methods can automatically deliver or present one or more custom map views and/or customized directions to a desired destination based on the automatic detection of the current location of an end user. This can be accomplished in part by employing location technology that can pinpoint the dynamic location of the end user and relate it to a static location of content (e.g., business, building, park, restaurant, store, etc.). The static location information can be correlated with the dynamic information in order to generate a customized map view of the destination with respect to the user's current location.

In addition, a customized set of directions can be provided to the end user via his/her computing device. The directions can be created with consideration of user preferences (e.g., user settings), weather conditions, time of day of intended travel, and many other factors. For example, given the same end user location and the same static location (destination), a different set of directions may be presented to the user based on historical traffic conditions, current traffic reports, time of day, and/or a user's preference to avoid tollways.

The systems and methods can also infer that the end user prefers the most reasonable route to travel to the selected destination. Therefore, when multiple static locations exist for the same content, the systems and methods can select the one located closest to the end user or the one that is most reachable by the end user in the shortest estimated amount of time. For instance, one route may be the shortest in terms of distance, but due to high traffic volumes, it may take longer than an alternative route which may actually require a few more miles of driving.

Given the growing concern over privacy for the end user, the systems and methods can also provide privacy control. Various permissions can be set or communicated to block location technologies from accessing and/or sharing the dynamic location with anyone or any other communications service or network.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a map generation system that facilitates automatically providing map related information with minimal user data input.

FIG. 2 is a block diagram of a map generation system that facilitates automatically providing map related information with minimal user data input as determined by privacy controls.

FIG. 3 is a block diagram of a map generation system that facilitates automatically providing map related information with minimal user data input in part by employing a location service and a mapping service that are either local or remote to the relevant (user) computing device.

FIG. 4 is a block diagram of a mapping control that can be incorporated in the map generation system of FIGS. 1-3.

FIG. 5 is a diagram that illustrates one exemplary environment involving a user using a portable or handheld computing device to obtain map information for a desired (static) location.

FIG. 6 is a diagram that illustrates another exemplary environment involving a user using a portable or handheld computing device to obtain map information for a desired (static) location.

FIG. 7 is a flow diagram illustrating an exemplary methodology that facilitates automatically providing map related information with minimal user data input.

FIG. 8 is a flow diagram illustrating an exemplary methodology that facilitates automatically providing map related information with minimal user data input and user permission for access to dynamic location information.

FIG. 9 is a flow diagram illustrating an exemplary methodology that facilitates automatically obtaining map related information for a desired static location based on a dynamic user location.

FIG. 10 illustrates an exemplary environment for implementing various aspects of the invention.

### DETAILED DESCRIPTION

The subject systems and/or methods are now described with reference to the drawings, wherein like reference numerals are used to refer to like elements throughout. In the following description, for purposes of explanation, numerous specific details are set forth in order to provide a thorough understanding of the systems and/or methods. It may be evident, however, that the subject systems and/or methods may be practiced without these specific details. In other instances, well- known structures and devices are shown in block diagram form in order to facilitate describing them.

As used herein, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

The subject systems and/or methods can incorporate various inference schemes and/or techniques in connection with determining the most relevant static location in view of the current dynamic location information. For example, a user may access web content for a clothing store. The clothing store has several (static) locations such as one location downtown (Downtown), another location west of downtown (West) and yet another location north of downtown (North). The user's current location data (e.g., dynamic location) can be obtained and based on this data, the systems and methods can infer that the closest and most reasonable location to direct the user to is the North location. By making such inferences, input by the user is further minimized and more meaningful location information can be provided to the user.

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Content creators such as businesses or individuals that advertise on the Web or maintain websites, for example, often include their address information so that customers can go to their places of business. Many of the content creators, however, make use of traditional mapping and/or navigation systems which often call for the end user to enter detailed information such as the user's current locality, the desired locality, and/or attributes of the area of interest. On a standard sized desktop computer or laptop, this process tends to be laborious at best but is very impractical on smaller more portable devices. Such smaller or handheld devices typically have user interfaces that are not well suited for data entry. Hence, accessing a navigable map with relevant and useful information can be challenging especially when on-the- go and needing accurate information quickly. The systems and methods presented herein mitigate many of these obstacles by providing additional local information at map generation time with minimal user input or action.

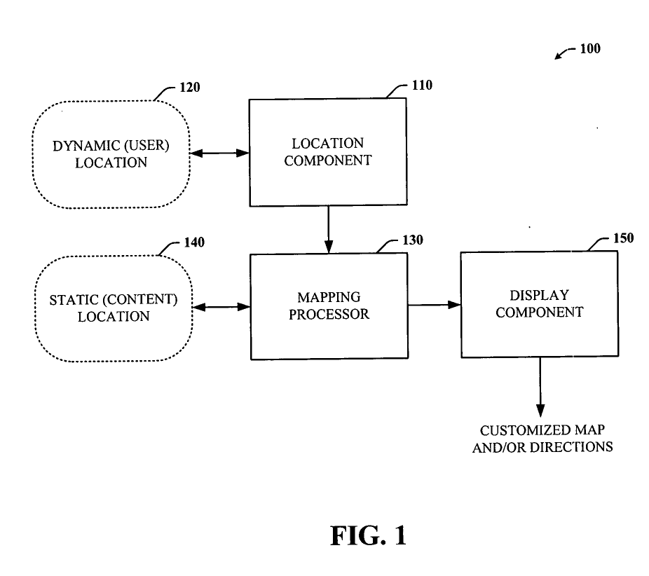

Referring now to FIG. 1, there is a general block diagram of a map generation system 100 that facilitates automatically providing map related information for some content with minimal user data input. The system 100 includes a location component 110 that can detect a current user location 120 (e.g., dynamic location). In particular, the location component can comprise a GPS device and related networks, a WiFi based location finder, GSM, IP address detection, or some other location identifiers. Once detected, the location component 110 can communicate the dynamic location data to a mapping processor 130. The static location for the content accessed or in view (by the user) can also be communicated to the mapping processor 130. The content can include Internet or Intranet content or other network-based content.

The mapping processor 130 can analyze and correlate the dynamic user location data with the static content location data in order to produce at least one map view of the static content location. For instance, a first map view can show the static content location without regard to the dynamic user location; and a second map view can show the static content location with respect to the dynamic user location and a suggested route from the user location to the content location. In addition, a set of directions can accompany the map view.

In some cases, the content can include more than one static location. Take for example a restaurant chain that has multiple locations within a metropolitan area. When multiple static locations exist for the content, the mapping processor 130 can analyze each static location with respect to the dynamic location and determine which static location can be more readily reached given such factors as the time of day, traffic volumes or patterns, road construction, traffic accident reports, and/or user preferences (e.g., exclude a specified highway). By default, the system 100 or the mapping processor 130 in particular can determine the optimum location given one or more of those factors and generate the respective map view(s) and/or directions. Thus, the determination depends on the dynamic location of the user. For instance, when a user is accessing the content from his office in downtown Chicago, the restaurant location on Michigan Avenue may be selected by the mapping processor 130 as the most convenient location and thus the most desirable destination. However, when the user accesses the same content from his house in the suburbs, a different location such as next to a nearby shopping plaza can be a more appropriate location.

A display component 150 can provide a custom map view(s) and/or customized directions according to the user's location and type of device employed by the user. Moreover, the system 100 can automatically determine the user's location and then generate specific map views and/or directions based on that location with nominal input by the user.

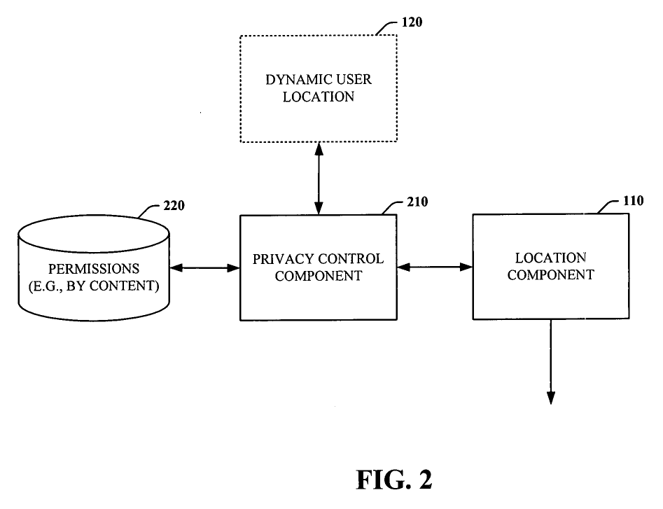

For many computer users, privacy concerns still remain at the forefront of their minds particularly with regard to personal safety and identity theft. As indicated in FIG. 2, a privacy control component 210 can be employed to mitigate or allay any concerns regarding access to the user's current location data. The privacy control component 210 can act as a communication gateway between the dynamic location 140 data and the location component 110. More specifically, the privacy control component 210 can access at least one database 220 (private or public) of permissions to determine if the location component 110 associated with the given content has a requisite access level to see or receive the dynamic location 140. Hence, the privacy control component 210 can effectively block any direct communication of the dynamic location 140 to the location component if the proper permission level is not obtained or in possession.

Depending on the system settings for privacy control, the location component 110 can be characterized as content specific meaning that it operates on behalf of some content (e.g., specific website). Therefore, the dynamic location 140 for any user can be communicated to the location component 110 when the content or the location component for that content has been given the required permission level. For example, each individual set of content such as individual websites can request permission by prompting the user just prior to map generation time. Hence, few if any privacy settings need to be made prior to using the system 100 (FIG. 1). Alternatively, the user can affirmatively identify content (e.g., websites) that has permission or conversely, content that does not have permission.

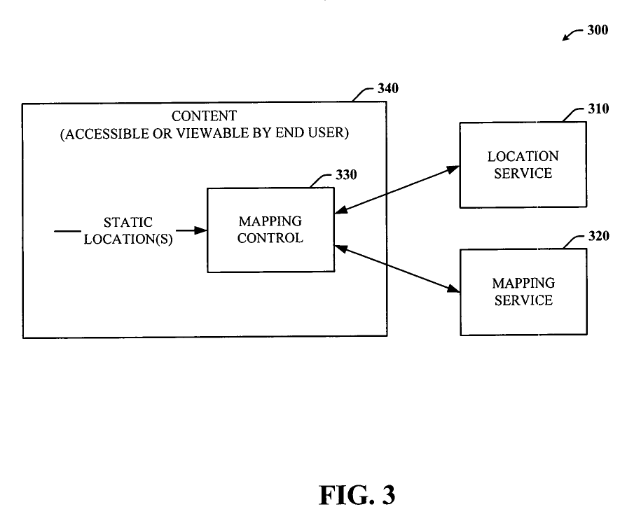

Turning now to FIG. 3, there is a block diagram of a map generation system 300 that facilitates automatically providing map related information with minimal user data input. This can be accomplished in part by employing a location service 310 and a mapping service 320 that are either local or remote to the relevant (user) computing device. The location service 310 can be a local process which runs on the user's device or in the form of a remote GPS device, for example, that delivers dynamic location data for any given user via http, SMS, or any other available communication means to a mapping control 330. The mapping control 330 can be embedded in some content 340 such as a web page which may be accessed or viewed by an end user. More specifically, during formation of the web page, its creator can embed a mini-application corresponding to the mapping control 330 that can automatically obtain any current data and then generate maps of that current data via the mapping service 320. Alternatively, the mapping control 330 can call the remote location service to obtain and process the current data remotely.

In practice for instance, the mapping control 330 can be activated by a press or click of a button. When activated, the mapping control 330 calls the location service 310 to fetch the current location data of a user. This location data as well as the static location data for the current content can be provided to the mapping service 320 via the mapping control 330. The mapping service 320 can then return customized map views based on all the above data—rather than just a generic map view of the content without consideration of the user.

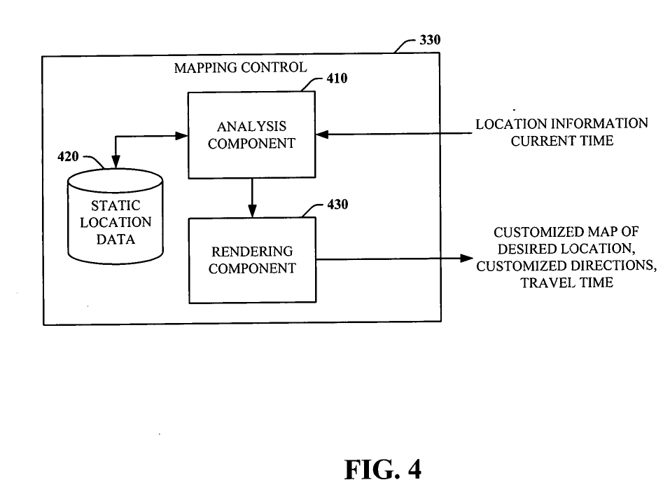

As demonstrated in FIG. 4, the mapping control 330 or processor (e.g., FIG. 1, 130) can include an analysis component 410 which can evaluate both static and dynamic location information as well as other factors such as time of day and current traffic conditions for the user's location as well as the content's location. The analysis of all of this data can be communicated to the mapping service before map generation time to further personalize the resulting map views. For example, the analysis component 410 can retrieve the content's static location from a local or remote network database 420. When more than one static location is available, the analysis component can determine which is the more relevant location based on the user's current location. Imagine that the content has static locations in three western states: California, Oregon, and Nevada. The user is accessing the content from Oregon. Thus, the analysis component 410 can determine that the Oregon static location is the most relevant for this particular user. A rendering component 430 can also be employed to communicate specific parameters to the mapping service for displaying the customized map views.

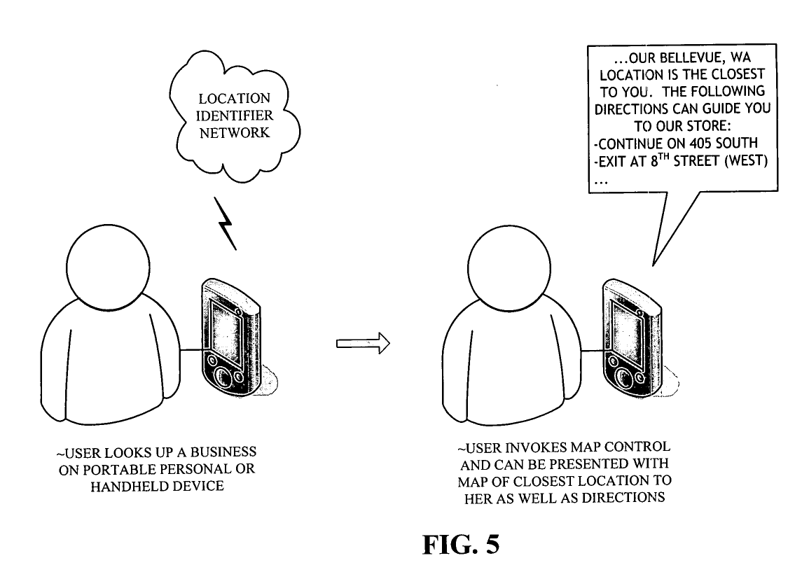

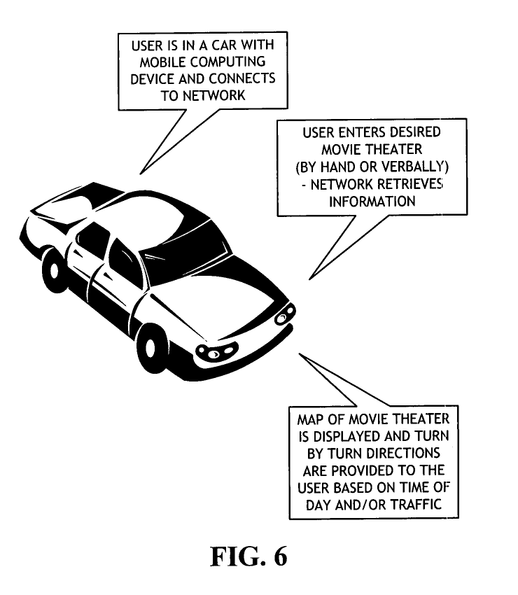

FIGS. 5 and 6 demonstrate two exemplary scenarios for the system as described herein. In particular, FIG. 5 illustrates one exemplary environment involving a user using a portable or handheld computing device to obtain map information for a clothing store. There is more than one store location but the user is not familiar with any of them. The user can access the store website or online phone book entry for the store on her handheld device (e.g., PDA or smart phone). To view a relevant map of the store, the user can click on a special map control. Assuming that permission is granted, a location identifier network can obtain the user's current location based at least in part on transmissions from the PDA. Almost immediately after the user invokes the map control button, a relevant map of the store location (closest to the user) with respect to the user's current location can be presented to the user. Customized directions can also accompany the map view for greater convenience.

FIG. 6 is a diagram that illustrates another exemplary environment involving a user using a portable or handheld computing device to obtain map information for a desired (static) location. Now imagine that the user is in a car and has decided to go to a movie but does not know where the movie theater is in relation to her current location. In fact, the user may be lost and not know her current location. Using her portable or handheld device again, she can connect to a network such as the Internet to access a movie theater website. After accessing the website, she can click on a mapping control on the site to obtain customized maps and/or driving directions to the closest movie theater without much if any input by her. That is, she is not required to enter her location in order to obtain the customized map view and driving directions from her location to the theater.

In-car navigation systems are often very costly upgrades in newer vehicles or are not typically compatible with older vehicles as an after-market installation. In addition, they are often limited to only information maintained in their databases and are not always updated with new businesses or new locations for existing businesses. However, through the use of any portable computing device, the user can have access to customized driving directions and map views with minimal input from just about anywhere whether on a train, in a car, or walking.

Various methodologies will now be described via a series of acts. It is to be understood and appreciated that the subject system and/or methodology is not limited by the order of acts, as some acts may, in accordance with the subject application, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject application.

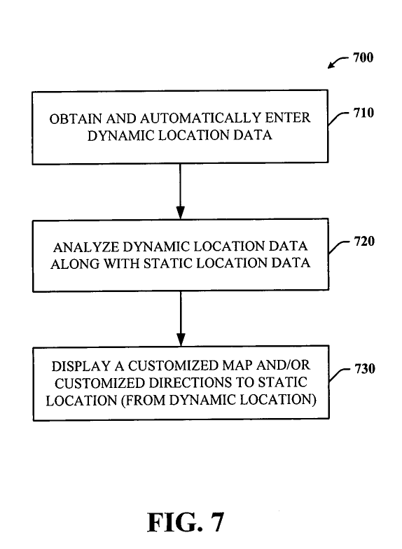

Referring now to FIG. 7, there is a flow diagram illustrating an exemplary method 700 that facilitates automatically providing map related information for content with minimal data input. The method 700 involves obtaining and automatically entering dynamic location data for any given user at 710. Therefore, the user is not required to enter this information. At 720, the dynamic location data can be analyzed with the static location data which corresponds to the content the user is viewing. At 730, a customized map and/or customized directions can be displayed that are both based on the user's current location.

The method 700 can be incorporated into content such as by the content's author. For example, imagine the content is a website or web page for an appliance store. The website can include a mapping feature that when selected, presents a map view of the store in relation to the viewer's location. This is unlike conventional mapping features which simply present a map of the store's location. Directions may be available using such conventional features but the user is required to enter their current location information. On some devices, this is a tedious and repetitive task when multiple sites are viewed to obtain their map information. However, on other devices, this task can be unrealistic and unfeasible given relatively small user interfaces and limited input means (e.g., no standard keyboard). Thus, the subject method 700 can obtain and input the user's current location and provide at least an informative map or set of directions based on the user's current location.

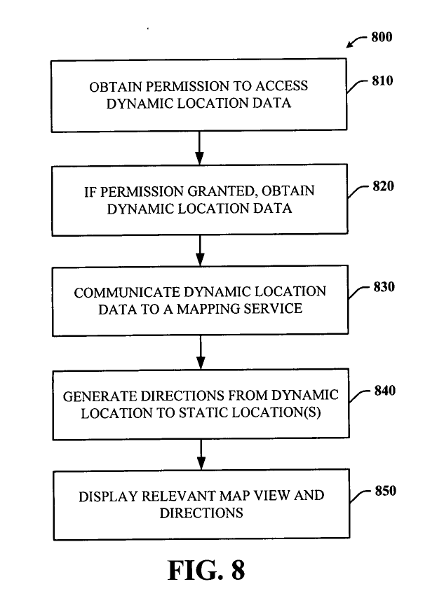

Referring now to FIG. 8, there is a flow diagram illustrating an exemplary method 800 that facilitates automatically providing map related information for some content with minimal user data input based on user permission for access to dynamic location information. The method 800 involves obtaining permission to access dynamic location data for the user at 810. If permission is granted at 820, then the dynamic location data can be obtained and communicated to a mapping service at 830. The mapping service can generate one or more map views based on the user's current location (dynamic location) and the content's static location at 840. At 850, the personalize map views can be presented to the user with or without a set of directions from the user's current location to the content's static location.

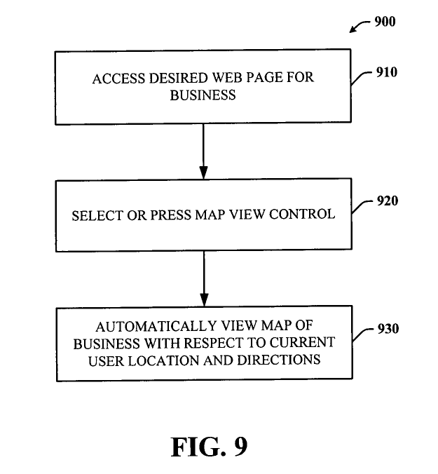

Turning now to FIG. 9, there is a flow diagram illustrating an exemplary method 900 that facilitates automatically obtaining map related information for a desired static location based on a dynamic user location. For example, the method involves accessing a desired web page for a store or business that the user would like to locate (at 910). At 920, the user can select or press a map view control on the web page and at 930, a map view can be automatically generated according to the user's current location and the static location of the business. Hence, minimal input from the user is required to obtain a customized map and/or a customized set of directions to the business from the user's current location.

The systems and/or methods discussed hereinabove can be employed on a variety of computing devices in conjunction with one or more data or communications networks. For example, map views or directions can be accessed on a desktop computer, laptop, PDA, mini laptop, smart phone, mobile phone, tablet PC, or other mobile computing device.

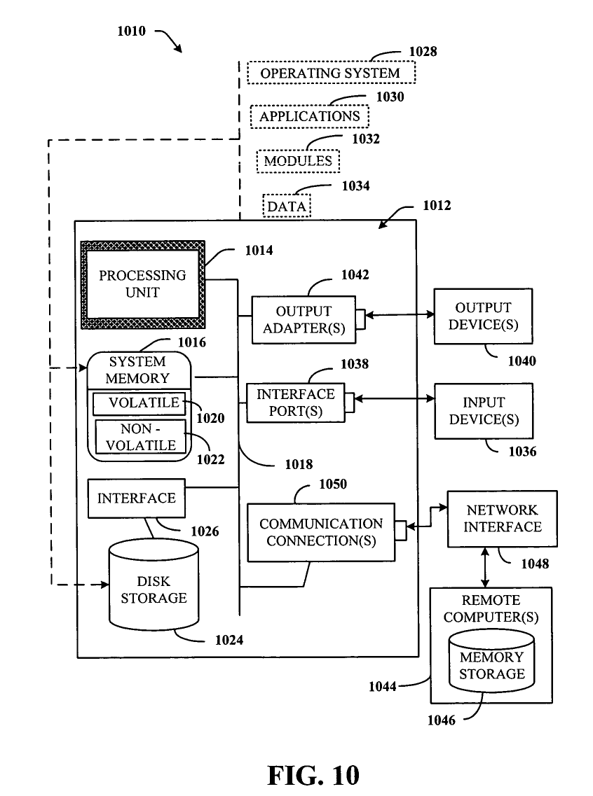

In order to provide additional context for various aspects of the subject invention, FIG. 10 and the following discussion are intended to provide a brief, general description of a suitable operating environment 1010 in which various aspects of the subject invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 1010 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 10, an exemplary environment 1010 for implementing various aspects of the invention includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). 100461 Computer 1012 also includes removable/nonremovable, volatile/nonvolatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the subject invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012 and to output information from computer 1012 to an output device 1040. Output adapter 1042 is provided to illustrate that there are some output devices 1040 like monitors, speakers, and printers among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject system and/or method. It is, of course, not possible to describe every conceivable combination of components or methodologies for purposes of describing the subject system and/or method, but one of ordinary skill in the art may recognize that many further combinations and permutations of the subject system and/or method are possible. Accordingly, the subject system and/or method are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A map generation system that facilitates automatically providing map related information with minimal user data input comprising:
a location component that automatically detects a dynamic location; and
a mapping processor that analyzes and correlates the dynamic location with respect to at least one static location to facilitate the generation of at least one customized map view of the static location with respect to the dynamic location.

2. The system of claim 1, wherein the static location corresponds to a location of network-based content.

3. The system of claim 1, wherein the content comprises at least one of a website or a web page.

4. The system of claim 1, wherein the dynamic location comprises a current user location.

5. The system of claim 1, wherein the location component comprises at least one of a GPS device, GSM, WiFi location finder, and IP detection.

6. The system of claim 1, wherein the mapping processor further facilitates the generation of at least one set of customized directions from the dynamic location to the static location.

7. The system of claim 1, wherein the mapping processor selects one static location that is most reachable from the dynamic location when more than one static location exists based at least in part on at least one of the following: time of day, current traffic conditions, historical traffic patterns, current weather conditions, distance between the dynamic and static locations, and user preferences.

8. The system of claim 1 further comprises a mapping service that generates at least one of the following: at least one customized map view of the dynamic location and selected static location and at least one set of customized directions that connect the dynamic location to the static location based on data received from the mapping processor.

9. The system of claim 1 further comprises a privacy control component that manages access to and communication of the dynamic location.

10. The system of claim 1 is employed remotely or locally on at least one of the following computing devices: desktop, laptop, PDA, smart phone, mobile phone, mini laptop, or any other portable handheld device where a user interface and input means are limited.

11. A map generation method that facilitates automatically providing map related information for content with minimal user data input comprising:
automatically detecting a dynamic location; and
analyzing and correlating the dynamic location with respect to at least one static location to facilitate the generation of at least one customized map view of the static location with respect to the dynamic location.

12. The method of claim 11 further comprises accessing the content to find its static location.

13. The method of claim 12 further comprises selecting to view at least one map view of the content's static location, wherein such selection triggers an automatic detection of the dynamic location.

14. The method of claim 12, wherein the dynamic location comprises a current location of the user and computing device that is accessing the content.

15. The method of claim 11, wherein detecting the dynamic location comprises employing at least one of the following to find a current location of a computing device: GPS, GSM, WiFi location identifier, and IP detection.

16. The method of claim 11 further comprises analyzing the dynamic location with respect to a plurality of static locations for the content; and selecting one static location that is most reachable from the dynamic location based at least in part on one of the following: distance, traffic conditions, time of day, user preferences, current weather conditions, and historical traffic patterns.

17. The method of claim 11 further comprises controlling automatic detection of the dynamic location in part by verifying a requisite permissions level.

18. The method of claim 11 further comprises automatically generating at least one of the following: at least one customized map view and at least one set of customized directions based on the dynamic location and at least one static location.

19. The method of claim 11 further comprises selecting one static location from a plurality of static locations that is most relevant to the dynamic location based in part on any one of the following: distance between the two locations, time of day, traffic conditions, weather conditions, and user preferences in order to facilitate generating at least one map view of the static location relative to the dynamic location.

20. A map generation system that facilitates automatically providing map related information for content with minimal user data input comprising:
means for automatically detecting a dynamic location; and
means for analyzing and correlating the dynamic location with respect to at least one static location to facilitate the generation of at least one customized map view of the static location with respect to the dynamic location.
